(19) United States
(12) Patent Application Publication
(10) Pub. No.: US 2002/0156616 A1
(43) Pub. Date: Oct. 24, 2002

(54) Interactive tool for semi-automatic creation of a natural language grammar from a domain model

(76) Inventor: Dale W. Russell, Palatine, IL (US)

Correspondence Address: MOTOROLA, INC., 1303 EAST ALGONQUIN ROAD, IL01/3RD, SCHAUMBURG, IL, 60196

(21) Appl. No.: 09/785,719

(22) Filed: Feb. 16, 2001

(51) Int. Cl. G06F 17/27; G10L 15/18

(52) U.S. Cl. 704/4; 704/257

(57) ABSTRACT

A system, method and program product for creating a grammar 100 for a natural language dialog system from a domain model. A template grammar 104 with parameterized rules to be instantiated is opened. A new grammar 102, initially empty, is created. Instances of general purpose grammar rules are created 106 and tentatively added to the new grammar. The general purpose grammar rules instances are domain objects of the new grammar, each including one or more attributes. The developer is offered the option of deciding whether to include each object 112 and which attributes 118 are kept in the new grammar. An umbrella rule is created 108 for each broad category of queries among the general purpose grammar rules. Each umbrella rule includes a domain-object-independent non-terminal in a left-hand side and a set of expansions of the non-terminal in a right-hand side. Objects are selectively included 112 as domain objects in the new grammar. Then, umbrella rules are created for domain object attributes 120 and, object attributes are selectively included 124 in the new grammar. Attributes are classified as either simple or complex 1204. Complex attributes relate one object to a subsidiary domain object. Then, a grammar checker is applied to the new grammar 200, 206 to prevent inclusion of unreachable non-terminals or non-terminating expansions in the final natural language dialog system grammar. Unreachable non-terminals may be removed or new rules may be added making them reachable at the developer's option 204. Non-terminating expansions may also be removed or appropriate rules may be added, also at the developer's option 208.

### RELATED APPLICATION

The present invention is related to U.S. patent application Ser. No. 09/______ (Attorney Docket No. CML00013-H) entitled “An Interactive Tool For Semi-Automatic Creation of a Domain Model” to Dale W. Russell, filed coincident herewith and assigned to the assignee of the present application.

### BACKGROUND OF THE INVENTION

1. Field of the Invention

The present invention is related to spoken language dialog systems and, more particularly, to methods of creating grammars for natural language dialog systems.

2. Background Description

One of the most difficult and time-consuming tasks in the developing Natural Language Dialog Systems is creating or adapting pre-existing grammars. This task requires a high degree of linguistic training and expertise. Typically, the most difficult part of this task is beginning, creating an initial set of grammar rules. Normally, grammars are derived from a given training corpus. However, such training corpora are expensive and difficult to obtain. If the target grammar is to contain semantic information, then the training corpus must be annotated for semantics, which requires additional time and expertise. Moreover, extracting an optimal grammar from a given corpus is difficult.

Unisys Corporation has a grammar development toolkit, entitled “Natural Language Speech Assistant” (NLSA), available that does not require a training corpus. Instead, the developer must formulate sample utterances. Essentially, the developer is presented with a blank slate and told to fill the slate with samples. If the developer fails to anticipate a full user utterance range, the coverage of the resulting grammar is inadequate.

In addition to the Unisys toolkit, other grammar development toolkits currently are available. Nuance provides a system entitled “Grammar Developer's Toolkit” that, like the Unisys system, has an intuitive interface for refining an existing grammar but, is difficult to use. Also, the English Wizard system from Linguistic Technology facilitates development of natural language dialog systems, but has grammar that is tightly integrated with its result, and cannot be used by other system components. Additionally, the English Wizard result cannot be examined and edited by the developer. Instead, the grammar is tightly integrated with the parser and not readily available for inspection as a distinct module.

Because of their many advantages, spoken language dialog systems development is an active area of current research and promises many products with a variety of applications. Such products may be used for receiving stock quotes, disseminating weather or yellow pages information, sending and receiving e-mail, as well as using a voice interface to browse the Internet. The main hurdle in getting new products to market is the time and expertise required to create or adapt necessary spoken dialog components, such as grammars, speech recognizers and dialog managers for new domains. Whoever can best streamline the process of porting these components to new domains will have a distinct advantage over others in this competitive field.

Thus, there is a need for an easy way to automatically create and refine grammars in a form that reflects an expert developer's conceptualization of the grammar. Also, there is a need for a suggested default set of grammar rules which a developer can then augment and refine as desired.

### BRIEF DESCRIPTION OF THE DRAWINGS

The foregoing and other objects, aspects and advantages will be better understood from the following detailed description of a preferred embodiment of the invention with reference to the drawings in which:

FIGS. 1A-B show a flow diagram wherein a new grammar is derived from a grammar template;

FIG. 2 is a flow diagram describing the steps in creating object grammar rules;

FIG. 3 is a flow diagram showing the steps of creating attribute grammar rules;

FIGS. 4A-B shows pseudocode corresponding to the preferred embodiment of the present invention of the flow diagrams of FIGS. 1-3;

FIG. 5 is a flow diagram of the final step wherein inconsistencies in the newly-created grammar are detected and repaired;

FIG. 6 shows pseudocode corresponding to the final step of FIG. 5.

### DETAILED DESCRIPTION OF A PREFERRED EMBODIMENT OF THE INVENTION

The present invention is a system, method and program product that allows any person, regardless of their level of grammar creation expertise to create a grammar from a grammar template.

A domain model is created as described in U.S. patent application Ser. No. 09/______ (Attorney Docket No. CML00013-H) entitled “An Interactive Tool for Semi-Automatic Creation of a Domain Model” to Dale W. Russell, filed coincident herewith, assigned to the assignee of the present application and incorporated herein by reference. From this domain model, the preferred embodiment of the present invention automatically creates default grammar rules that are suggested to the developer. Then, the developer has the option of accepting, rejecting, augmenting or revising the default rules and testing their coverage using the present invention.

Applications using Spoken Language Dialog Systems primarily fall into one of two categories: query or, command and control. For each of these, it is possible to anticipate the linguistic form of many user utterances. These anticipated linguistic forms can be expressed in a domain-independent formulation called a template grammar. A template grammar is supplied to the grammar developer. The template grammar is then specialized for a given application domain according to an algorithm that operates on one object of the domain model at a time and on one attribute at a time for each object. Thus, for each object and for each attribute, the preferred embodiment tool retrieves relevant rules from the template grammar and specializes the retrieved rules for the given object and/or attribute to generate a set of default rules. The default rules are then presented to the developer. The developer can accept, reject, augment or revise the default rules, and test their coverage with a set of grammar tools.

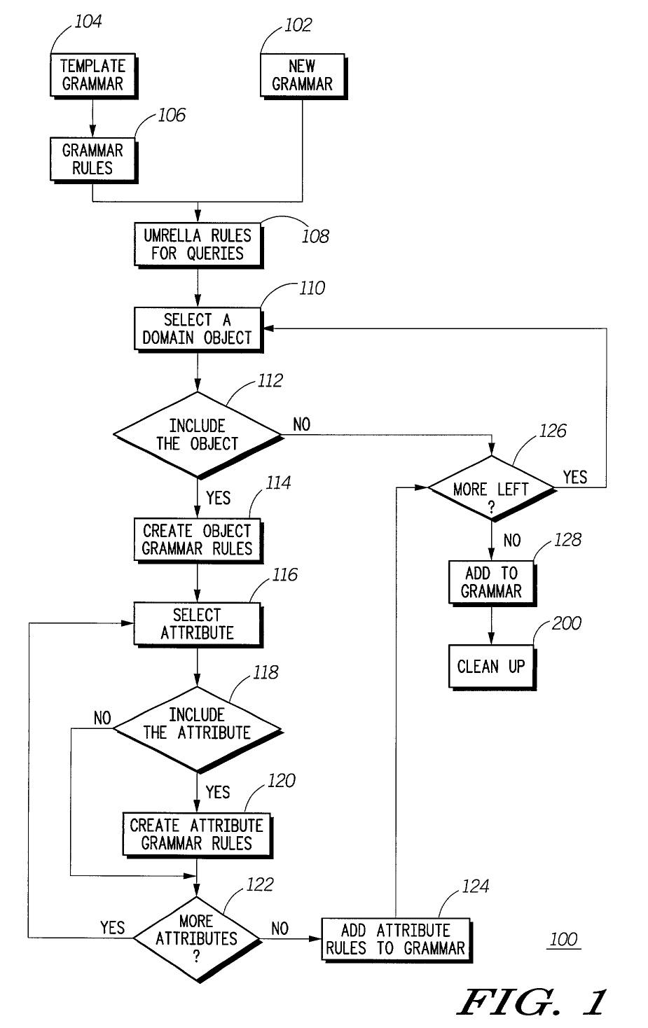

FIGS. 1A-B are a flow diagram of the preferred embodiment method 100 of induction of a grammar from a domain model. First, in step 102, a new grammar is created. Initially, the new grammar is empty. Then, in step 104, a template grammar is opened. The template grammar includes parameterized general purpose rules that are to be instantiated. In step 106, instances are created from general purpose grammar rules and, the general purpose grammar rule instances are added to the new grammar. In step 108, an umbrella rule is created for each of the broad category of queries in the new grammar. Each umbrella rule subsumes the rules for that type of query. The umbrella rules each include domain object independent non-terminals on the left-hand side relating the rule to a broad category of rules. The right-hand side is a set of expansions of corresponding non-terminals. These expansions are each a domain object-specific substantiation of the broad category.

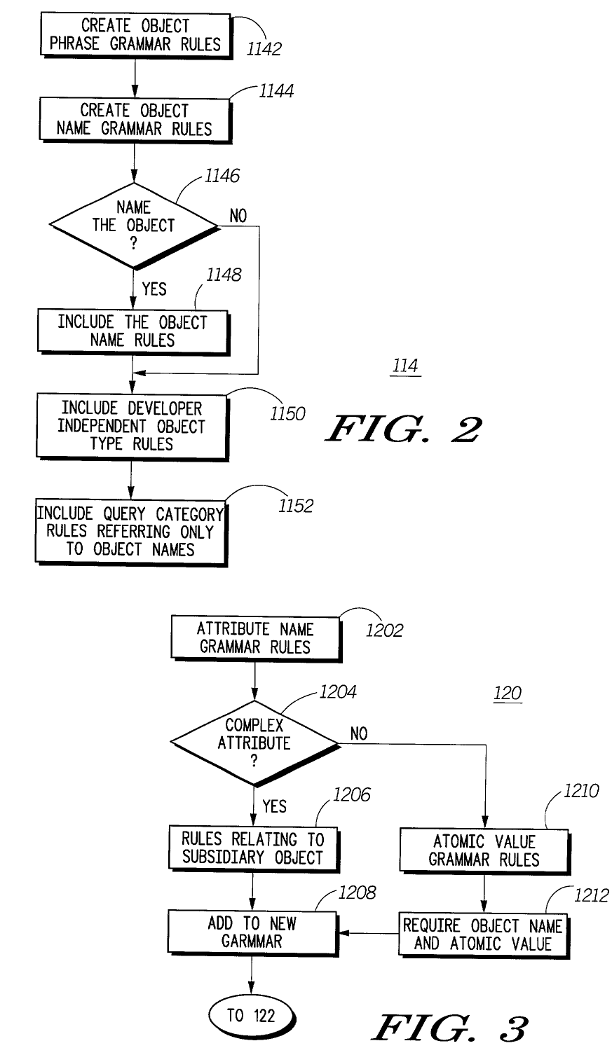

Continuing, in step 110, the domain objects are selected one at a time and in step 112, the developer is allowed to decide whether to include the selected domain object or not. If the developer decides to include the domain object, then in step 114, object grammar rules are created for that domain object as is described more fully herein below with reference to FIG. 2. In step 116, attributes from included domain objects are presented to the developer, one attribute at a time and in step 118, the developer can decide whether or not to include the selected attributes in the grammar. If the developer does decide to include the attributes, then, in step 120, attribute grammar rules are created for the attribute as described in detail herein below with reference to FIG. 3. In step 122, the object is checked to determine whether any attributes remain as yet unselected and, if so, returning to step 116, attribute selection continues. Once in step 122, all of the domain attributes have been selected and either included or excluded, then in step 124, the umbrella rules for included attributes are added to the grammar. In step 126, a check is made of whether additional domain objects remain unselected. If additional domain objects remain, then, returning to step 110, the next domain object is selected. If, however, no additional objects remain, then in step 128, the query level umbrella rules are added to the new grammar. Finally, in cleanup step 200, the newly-created grammar is finalized as inconsistencies are detected and repaired.

Thus, an inexperienced developer, accepting all of the default specialized template rules receives a fully functional grammar, although coverage may be less than optimal. Alternatively, a more experienced developer with some knowledge of the domain may accept some proposed grammar rules, reject others, add new expansions for given rules and modify existing expansions.

As indicated hereinabove, FIG. 2 is a flow diagram describing the step 114 of creating object grammar rules. First, in step 1142, an object phrase grammar rule is created for each category of object phrases. The object phrase grammar rules are each an umbrella rule that subsumes rules for that particular type of object phrase. In step 1144, object-name rules and object-name-poss grammar rules are created, where the object-name-poss rule specifies the possessive form of the name of the particular object. In step 1146, the developer is allowed to select object names. The developer is presented with the name of the domain object as the default name for the object and allowed to provide other object names. In step 1148, each name selected by the developer, including the default name, if selected, is included in the object. A right-hand side is added to the object-name rule, expanding to include each selected name and, correspondingly, a right-hand side is also added to the object-name-poss rule, expanding to include the possessive form of the entered name. Then, both the object-name rule and the object-name-poss rule are added to the new grammar.

Continuing, in step 1150, developer-independent specialized rules are added to the new grammar. So, for each type of object rule using the domain object name, but that does not require developer input, appropriate parameterized rules are retrieved from the template grammar. The retrieved rules are specialized for the particular domain object and, then, added to the new grammar. Finally, in step 1152, entry level rules that require only domain object names are added to the new grammar. So, the appropriate parameterized rule is retrieved for the new grammar and specialized for the particular domain object. The specialized rule is added to the new grammar. A new right-hand side is added to the query level rule and the left-hand side is expanded in the specialized rule. Domain object processing continues in step 116, as domain attributes are selected for the main object, selectively included in step 118 and grammar rules are created for the included attributes in step 120.

FIG. 3 is a flow diagram showing the step 120 of creating attribute grammar rules. First, in step 1202, grammar rules are generated using the named domain attribute and, optionally, the name of the domain object. Then, the generated grammar rules are added to the new grammar. Next, in step 1204, the domain attribute is checked to determine if it is complex, i.e., it represents a subsidiary of a domain object. If the domain object is complex, then in step 1206, grammar rules are created relating the subsidiary domain object to the domain object. In step 1208, the newly created grammar rule is added to the new grammar and, a new right-hand side is added to the umbrella rule for the complex domain object, correspondingly, expanding to the left-hand side for this newly-created rule.

Otherwise, if in step 1206 the domain object is not complex, then in step 1210, grammar rules are created for atomic values of the simple domain attribute. These newly created atomic value grammar rules are then added to the new grammar and, in step 1212, grammar rules are created that require the name of the simple domain object and the atomic value of the domain attribute. In step 1214, the newly created grammar rule is added to the new grammar and the new right-hand side is added to the umbrella rule for the simple domain object as well as, correspondingly, expanding the right-hand side of the umbrella rule. Once umbrella rules are created for domain object attributes and included in the new grammar and, query level umbrella rules have been created and included in the new grammar in step 128, the grammar is checked in step 200 for inconsistencies, removing any that are found.

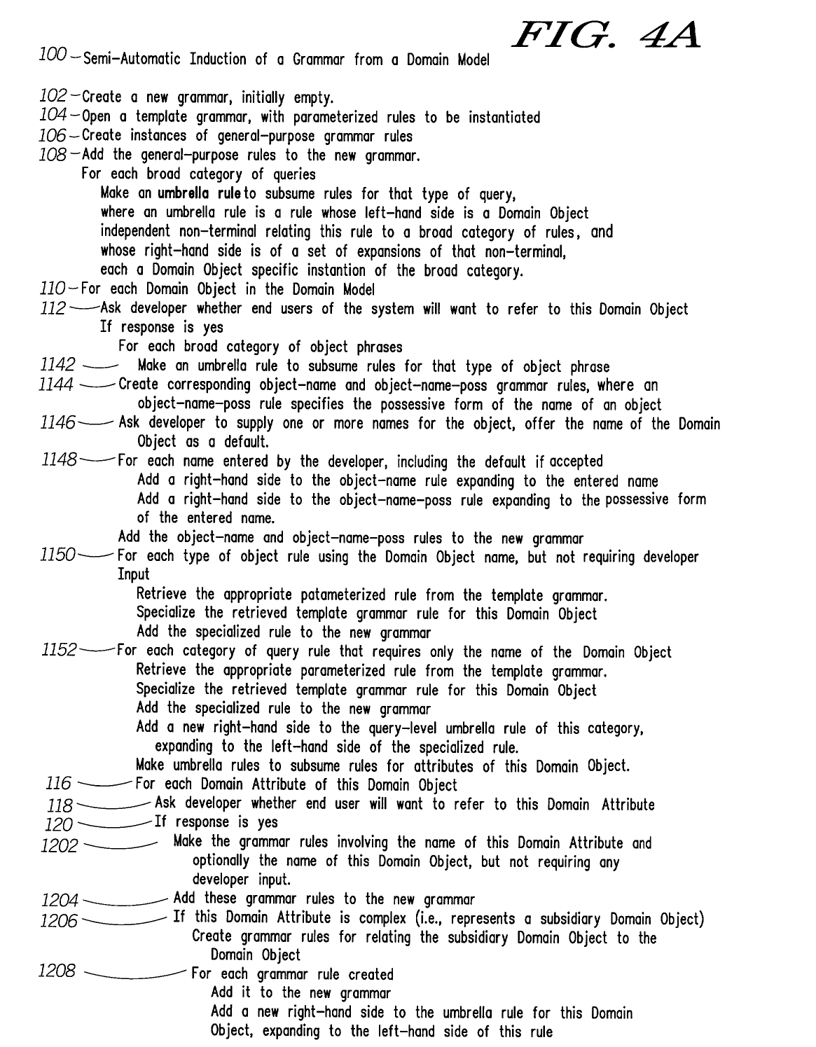

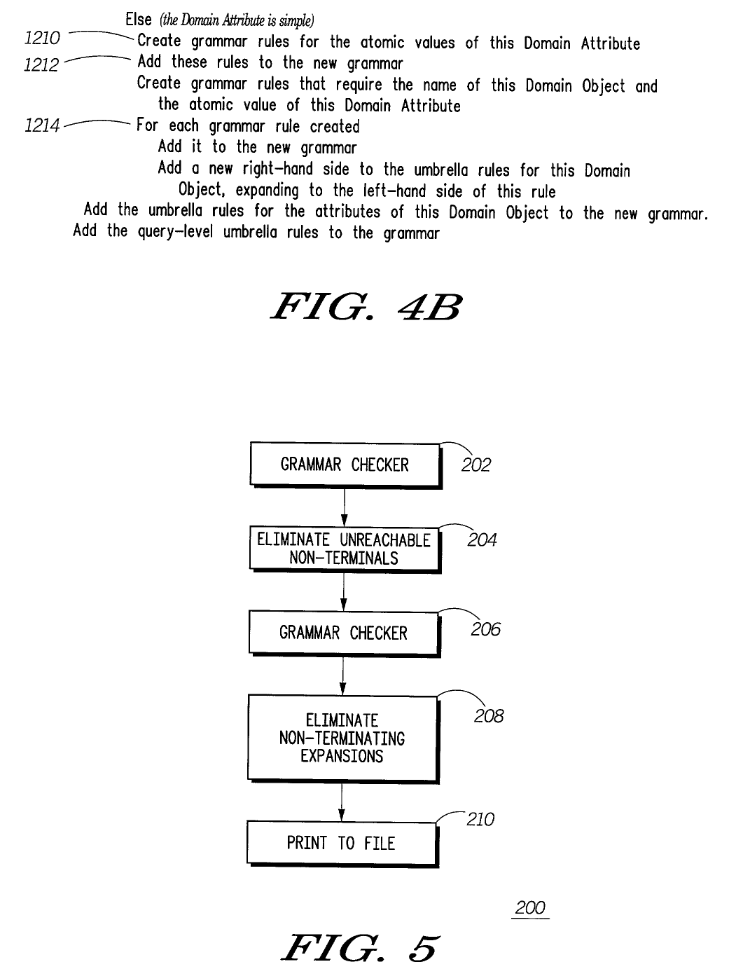

FIGS. 4A-B shows pseudocode for the preferred embodiment corresponding to the flow charts of FIGS. 1-3.

As described herein above, a template grammar is a set of general purpose parameterized rules or template rules. A template rule is a grammar rule which is parameterized for domain objects and attributes. That is, some or all non-terminal or terminal categories in a template rule may be abstractions over objects or attributes. These abstract categories are instantiated for particular objects and attributes, thus creating an actual grammar rule. So, for an example of a template rule:

<Object_adj_Attribute> :: =

( ( <Attribute_value> :Attribute1 )

{ ( VALUE ( APPEND Attribute $Attribute1 ) ) }

)
.

Working with an airline domain, for example, one way that this template rule might be specialized:

Specialize Object to “flight”

Specialize Attribute to “airline”

Then, the specialized rule would then be:

<flight_adj_airline> ::=

( ( <airline_value> :airline1 )

{ (VALUE ( APPEND airline $airline1 ) ) }

)
.

The <airline_value> expands to, for example, “delta” and “united,” which, along with other rules, allows a user to make requests such as: “show me the delta flights” or “I want to get a united flight” and the like. During the course of creating an application grammar, a single template rule may be used many times, specialized in different ways. The template rules represent very general language patterns, which occur over and over again. The template rule above indicates that an attribute may be instantiated as an adjective that is used to modify a noun representing an object having that attribute. There are many such patterns, each encoded in a template rule.

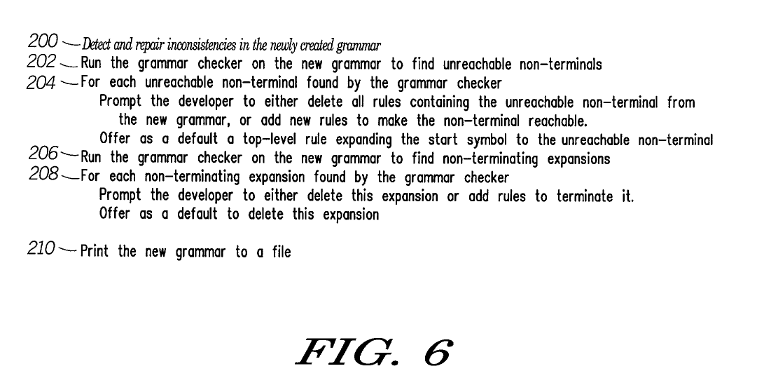

FIG. 5 is a flow diagram of the final step 200 wherein inconsistencies in the newly-created grammar are detected and repaired and FIG. 6 is corresponding pseudocode. First, in step 202, the grammar checker is run on the new grammar to determine if any unreachable non-terminals exist. In step 204, the developer is prompted to either delete rules containing the unreachable non-terminals for the new grammar or, add rules to make the non-terminal rules reachable. Then, in step 206, the grammar checker is re-run on the grammar to find and list any non-terminating expansions. In step 208, again, prompting the developer, either the expansion is deleted by default or, rules are added to terminate the particular expansion. Finally, in step 210, the new completed grammar is printed to a file.

An appropriate interface, such as a graphical user interface (GUI), allows developers to choose an object or attribute from the Domain Model and work on grammar rules related to that selected object or attribute. When an object or attribute is selected, any grammar rules already created by the developer are displayed. Otherwise, if no rules have yet been created for a selected object or attribute, a default set of rules is created and displayed. The interface also displays the current state of completion of the grammar rules. At any time, the developer may further refine previously created rules.

Accordingly, the present invention automatically provides grammar rules to a developer. The developer may accept, reject, augment or revise the default rules as desired. Once the developer is satisfied with the grammar, it is tested and any defects corrected. The resulting grammar is automatically generated without requiring any particular level of expertise on the part of the developer.

While the invention has been described in terms of preferred embodiments, those skilled in the art will recognize that the invention can be practiced with modification within the spirit and scope of the appended claims.

I claim:

1. A method of creating a grammar for a natural language dialog system from a domain model, said method comprising the steps of:
a) creating instances of general purpose grammar rules as a new grammar, said general purpose grammar rules including a plurality of selected objects, each of said objects including one or more attributes;
b) creating an umbrella rule for each broad category of queries in said general purpose grammar rules;
c) selectively including objects as domain objects in said new grammar;
d) creating umbrella rules for domain object attributes; and
e) selectively including attributes in said new grammar.

2. A method as claim 1, wherein the step (a) of creating the new grammar comprises the steps of:
i) creating an initially empty new grammar;
ii) opening a template grammar, said template grammar including parameterized general purpose rules to be instantiated;
iii) creating instances of said general purpose grammar rules; and
iv) adding the instantiated general purpose rules to said new grammar.

3. A method as in claim 1, wherein each said umbrella rule includes a domain-object-independent non-terminal in a left-hand side and a set of expansions of said non-terminal in a right-hand side.

4. A method as in claim 3, wherein each of said set of non-terminal expansions is a domain-specific instantiation of the broad category.

5. A method as in claim 3, wherein the domain-object-independent non-terminal relates the umbrella rule to a broad category of rules.

6. A method as in claim 1, wherein the step (c) of selectively including objects comprises the steps of:
i) selecting an object from said plurality of objects; and
ii) presenting said selected object to a developer, said developer deciding whether said object is included in said new grammar.

7. A method as in claim 6, wherein if said developer decides that said selected object should be included in said grammar, said method further comprises the steps of:
c1) creating an umbrella rule for each broad category of object phrases;
c2) creating an object name grammar rule for each created umbrella rule;
c3) allowing the developer to select names for the included object; and
c4) adding entries in said grammar for each selected name.

8. A method as in claim 7, wherein the object name grammar rules created in step (c2) further includes an object name possessive rule, said object name possessive rule specifying the possessive form of the name of said object.

9. A method as in claim 8, said method further comprising the steps of:
c5) specializing object rules not requiring developer input; and
c6) specializing query rules requiring only the name of the domain object.

10. A method as in claim 1, wherein in step (e) the developer selects whether an attribute is included in the new grammar.

11. A method as in claim 10, wherein if the developer selects an attribute for inclusion, said method further comprises the steps of:
f) including attribute name grammar rules naming said attributes;
g) identifying whether said named attribute is complex or simple.

12. A method as in claim 11, wherein in step (g) if an attribute is identified as complex, said method comprising the steps of:
vi) creating grammar rules relating the object including said complex attribute to a subsidiary domain object; and
vii) adding said created relating grammar rules to said new grammar.

13. A method as in claim 11, wherein in step (g) if said attribute is identified as simple, said method further comprising the steps of:
vi) creating grammar rules for the atomic values of the simple attribute;
vii) adding said created atomic value grammar rules to said new grammar;
viii) creating grammar rules requiring the name of the object including the simple attribute and the atomic value of the domain attribute; and
ix) adding said grammar rules created in step (iii) to said new grammar.

14. A method as in claim 1, said method further comprising the step of:
(h) detecting and repairing inconsistencies in the newly-created grammar.

15. A method as in claim 14, wherein the step (f) of detecting and repairing inconsistencies comprises the steps of:
i) running a grammar checker on the new grammar, said grammar checker identifying unreachable non-terminals;
ii) repairing said newly-created grammar to eliminate identified unreachable non-terminals;
iii) running said grammar checker on said repaired new grammar, said grammar checker identifying non-terminating expansions; and
iv) repairing said new grammar to eliminate identified non-terminating expansions.

16. A method as in claim 15 wherein the step (ii) of eliminating unreachable non-terminals comprises the steps of:
F) prompting the developer to delete unreachable non-terminals; and
G) prompting the developer to add new rules to make all remaining non-terminals reachable.

17. A method as in claim 15, wherein the step (ii) of eliminating non-terminating expansions comprises the steps of:
F) prompting the developer to delete identified non-terminating expansions; and
G) prompting the developer to add rules terminating all remaining said non-terminating expansions.

18. A system for creating a natural language dialog grammar from a domain model, said system comprising:
means for forming a new grammar including instances of general purpose grammar rules, said instances of general purpose rules being a plurality of objects, each of said objects including one or more attributes;
means for creating umbrella rules for query categories and attributes;
means for selecting objects included as domain objects in said new grammar;
means for selecting attributes included in said new grammar; and
means for detecting and repairing inconsistencies in said new grammar.

19. A system as in claim 18, wherein the means for forming the new grammar comprises:
means for creating an initially empty new grammar;
means for opening a template grammar including parameterized general purpose rules;
means for creating instances of general purpose rules; and
means for adding the general purpose rules to said new grammar.

20. A system as in claim 19, wherein said means for creating umbrella rules creates a rule with a left-hand side being a domain-object-independent non-terminal and a right-hand side including a set of expansions of said non-terminal, each of said set of non-terminal expansions being a domain-specific instantiation of the broad category, said non-terminal relating the rule to a broad category of rules.

21. A system as in claim 18, wherein the means for selectively including objects comprises:
means for selecting objects;
means for presenting said selected objects to a developer, said developer deciding whether said presented objects are included in said new grammar.

22. A system as in claim 21, further comprising:
means for creating an umbrella rule for a broad category of object phrases;
means for creating object name grammar rules for umbrella rules;
means for receiving a name selection from a developer; and
means for entering names in said grammar responsive to selection by said developer.

23. A system as in claim 22, wherein the means for creating object name rules further includes means for creating an object name possessive rule, said object name possessive rule specifying the possessive form of the name of said object.

24. A system as in claim 23, said system further comprising:
means for automatically specializing object rules; and
means for specializing query rules responsive only to the name of the domain object.

25. A system as in claim 18, wherein the means for selecting attributes included in the new grammar comprises:
means for presenting said attributes to a developer, said developer deciding whether each of said presented attributes is included.

26. A system as in claim 25, said system further comprising:
means for generating attribute name grammar rules for selected said attributes;
complex attribute grammar rule creation means for identifying attributes, relating the object to a subsidiary domain object as complex attributes, grammar rules being created for said complex attributes and added to said new grammar;
atomic value grammar rule creation means for identifying simple attributes, creating grammar rules for atomic values of identified simple attributes and, adding said atomic value grammar rules to said new grammar; and
simple attribute grammar rule creation means for creating simple attribute grammar rules requiring the name of simple objects and a corresponding atomic value and adding said simple attribute grammar rules to said new grammar.

27. A system as in claim 18, wherein the means for detecting and repairing inconsistencies comprises:
means for identifying unreachable non-terminals;
means for eliminating unreachable non-terminals from said new grammar;
means for identifying non-terminating expansions; and
means for eliminating non-terminating expansions from said new grammar.

28. A system as in claim 27, wherein the means for eliminating unreachable non-terminals comprises:
means for allowing a developer to delete identified unreachable non-terminals; and
means for allowing the developer to add new rules making identified unreachable non-terminals reachable.

29. A system as in claim 28, wherein the means for eliminating non-terminating expansions comprises:
means for allowing the developer to delete identified non-terminating expansions; and
means for allowing the developer to add rules terminating said identified non-terminating expansions.

30. A computer program product for creating a natural language dialog grammar from a domain model, said computer program product comprising a computer usable medium having computer readable program code thereon, said computer readable program code comprising:
computer readable program code means for forming a new grammar including instances of general purpose grammar rules, said instances of general purpose rules being a plurality of objects, each of said objects including one or more attributes;
computer readable program code means for creating umbrella rules, umbrella rules being created for query categories and for attributes; and
computer readable program code means for selecting objects and attributes included as domain objects and domain object attributes in said new grammar.

31. A computer readable program code means for creating a natural language grammar from domain models as in claim 30, wherein the computer readable program code means for forming the new grammar comprises:
computer readable program code means for creating an initially empty new grammar;
computer readable program code means for opening a template grammar including parameterized general purpose rules to be instantiated;
computer readable program code means for creating instances of general purpose rules; and
computer readable program code means for adding the instantiated general purpose rules to said new grammar.

32. A computer readable program code means for creating a natural language grammar from domain models as in claim 31, wherein said computer readable program code means for creating umbrella rules creates rules with a left-hand side being a domain-object-independent non-terminal and a right-hand side including a set of expansions of said non-terminal, each of said set of non-terminal expansions being a domain-specific instantiation of the broad category, said non-terminal relating the rule to a broad category of rules.

33. A computer readable program code means for creating a natural language grammar from domain models as in claim 32, wherein the computer readable program code means for selecting objects and attributes comprises:
computer readable program code means for individually selecting objects; and
computer readable program code means for presenting said selected objects to a developer, said developer deciding whether said presented objects are included in said new grammar.

34. A computer readable program code means for creating a natural language grammar from domain models as in claim 33, wherein the computer readable program code means for selecting objects and attributes further comprises:
computer readable program code means for presenting selected said attributes to a developer, said developer deciding whether each of said presented attributes is included in said new grammar.

35. A computer readable program code means for creating a natural language grammar from domain models as in claim 34, wherein the computer readable program code means for creating umbrella rules further creates umbrella rules for a broad category of object phrases, said computer readable program code means further comprising:
computer readable program code means for creating object name grammar rules for umbrella rules;
computer readable program code means for receiving a name selection from a developer, said name selection selectively including said object name created by said computer responsive to creating said object name grammar rules; and
computer readable program code means for entering names in said new grammar responsive to selection by said developer.

36. A computer readable program code means for creating a natural language grammar from domain models as in claim 35, wherein the computer readable program code means for creating object name rules further includes computer readable program code means for creating an object name possessive rule, said object name possessive rule specifying the possessive form of the name of said object.

37. A computer readable program code means for creating a natural language grammar from domain models as in claim 36, said system further comprising:
computer readable program code means for automatically specializing object rules; and
computer readable program code means for specializing query rules responsive only to the name of the domain object.

38. A computer readable program code means for creating a natural language grammar from domain models as in claim 35, further comprising:
computer readable program code means for generating attribute name grammar rules for selected said attributes;
computer readable program code means for identifying attributes relating to a subsidiary domain object as complex attributes, grammar rules being created for said complex attributes and added to said new grammar;
computer readable program code means for identifying simple attributes, creating grammar rules for atomic values of simple attributes, and adding said atomic value grammar rules to said new grammar; and
computer readable program code means for creating simple attribute grammar rules requiring the name of simple objects and a corresponding atomic value and, adding said simple attribute grammar rules to said new grammar.

39. A computer readable program code means for creating a natural language grammar from domain models as in claim 30, said system further comprising:
computer readable program code means for detecting and repairing inconsistencies in newly-created grammar.

40. A computer readable program code means for creating a natural language grammar from domain models as in claim 39, wherein the computer readable program code means for detecting and repairing inconsistencies comprises:
computer readable program code means for identifying unreachable non-terminals;
computer readable program code means for eliminating unreachable non-terminals;
computer readable program code means for identifying non-terminating expansions; and
computer readable program code means for eliminating non-terminating expansions.

41. A computer readable program code means for creating a natural language grammar from domain models as in claim 40, wherein the computer readable program code means for eliminating unreachable non-terminals comprises:
computer readable program code means for selectively deleting identified unreachable non-terminals; and
computer readable program code means for selectively adding new rules making identified unreachable non-terminals reachable.

42. A computer readable program code means for creating a natural language grammar from domain models as in claim 41, wherein the computer readable program code means for eliminating non-terminating expansions comprises:
computer readable program code means for selectively deleting identified non-terminating expansions; and
computer readable program code means for selectively adding rules terminating identified non-terminating expansions.
